(19) United States
(12) Patent Application Publication
(10) Pub. No.: US 2015/0153593 A1
(43) Pub. Date: Jun. 4, 2015

(54) SUBSTRATE INSPECTION APPARATUS INCLUDING LIQUID CRYSTAL MODULATOR AND MANUFACTURING METHOD OF THE LIQUID CRYSTAL MODULATOR

(71) Applicants: Samsung Display Co., Ltd., Yongin-City (KR); Samsung Electronics Co., Ltd., Suwon-si (KR)

(72) Inventors: Sung-Mo GU, Daegu (KR); SUK CHOI, Seongnam-si (KR); Youngjin NOH, Ansan-si (KR); YOUNGWON KIM, Yongin-si (KR); Changhyun RYU, Cheonan-si (KR); CHI YOUN CHUNG, Seoul (KR)

(21) Appl. No.: 14/316,525

(22) Filed: Jun. 26, 2014

(30) Foreign Application Priority Data
Dec. 3, 2013 (KR) 10-2013-0149220

(51) Int. Cl. G02F 1/13; H01B 13/00; B05D 1/00

(52) U.S. Cl. CPC G02F 1/1313; B05D 1/005; H01B 13/0026

(57) ABSTRACT

A substrate inspection apparatus includes a liquid crystal modulator configured to be provided on a substrate, a light source unit provided to be spaced apart from the liquid crystal modulator, a beam splitter provided between the liquid crystal modulator and the light source unit configured to reflect a beam of light from the light source to the liquid crystal modulator, and a measurement unit configured to sense the beam of light reflected by the substrate.

### CROSS-REFERENCE TO RELATED APPLICATIONS

This US non-provisional patent application claims priority under 35 USC §119 to Korean Patent Application No. 10-2013-0149220, filed on Dec. 3, 2013, the entirety of which is hereby incorporated by reference in its entirety.

### BACKGROUND OF THE INVENTION

This disclosure relates to a substrate inspection apparatus including a liquid crystal modulator and, more particularly, to a substrate inspection apparatus for detecting defects of a substrate and a manufacturing method of a liquid crystal modulator incorporated in the substrate inspection apparatus.

Recently, display devices such as liquid crystal display (LCD), organic light emitting display (OLED), and plasma discharge panel (PDP) have been developed. These display devices have high resolution, ultra-slimness, light weight, and superior viewing angle characteristics.

Such a display device includes pixels to display images. Each of the pixels may include pixel electrodes and driving circuits, such as thin film transistors, which correspond to the pixel electrode and are electrically connected to the pixel electrodes, respectively. There is a need to inspect defects of the pixel electrodes and the driving circuits of the display device.

### SUMMARY OF THE INVENTION

Some embodiments provide a substrate inspection apparatus including a liquid crystal modulator and a manufacturing method of a liquid crystal modulator of a substrate inspection apparatus.

In some embodiments, a substrate inspection apparatus for detection a defect of a substrate may include a liquid crystal modulator configured to be provided on the substrate; a light source unit provided to be spaced apart from the liquid crystal modulator; a beam splitter provided between the liquid crystal modulator and the light source unit to reflect a beam of light from the light source to the liquid crystal modulator; and a measurement unit adapted to sense the beam of light reflected from the liquid crystal modulator. The liquid crystal modulator includes a transparent substrate; a common electrode provided on the transparent substrate; a liquid crystal layer provided on the transparent substrate to be in contact with the common electrode; and a reflection layer provided on a polymer network liquid crystal.

In some embodiments, the light source unit may include a light source to emit the beam of light; a beam homogenizer to direct the beam of light emitted from the light source; and a reflector to reflect the beam of light emitted from the beam homogenizer in a direction of the beam splitter. The beam homogenizer may be provided in the form of rod pipe.

In some embodiments, the substrate inspection apparatus may further include a first support part provided on the reflection layer to support the reflection layer and the liquid crystal layer. The first support part includes a first support sheet; a protection layer provided on one surface of the first support sheet to protect the first support sheet; and a hard coating layer provided on the other surface of the first support sheet. The protection layer is provided between the first support sheet and the reflection layer.

In some embodiments, the reflection layer may comprise a dielectric mirror. The reflection layer may include a plurality of first dielectric layers having a first refractive index; and a plurality of second dielectric layers having a refractive index differing from the first refractive index. The first dielectric layers and the second dielectric layers may be alternately arranged.

In some embodiments, the liquid crystal layer may include a polymer network liquid crystal.

In some embodiments, the substrate inspection apparatus may further include an adhesive provided between the transparent substrate and the common electrode; and a second support part provided between the common electrode and the adhesive layer to support the common electrode.

In some embodiments, a manufacturing method of a liquid crystal modulator of a substrate inspection apparatus may include forming a common electrode on a transparent substrate; forming a liquid crystal layer directly on the common electrode; and forming a reflection layer on the liquid crystal layer.

In some embodiments, the manufacturing method may further include forming a support part on the reflection layer. The support part may be formed by preparing a first support sheet, forming a protection layer on one surface of the first support sheet, and forming a hard coating layer on the other surface of the first support sheet.

In some embodiments, the liquid crystal may be formed by coating a polymer network liquid crystal composition on the common electrode and curing the polymer network liquid crystal composition.

In some embodiments, the reflection layer may be a dielectric mirror. In this case, the reflection layer may be formed by alternately stacking a plurality of first dielectric layers having a first refractive index and a plurality of second dielectric layers having a refractive index differing from the first refractive index.

### BRIEF DESCRIPTION OF THE DRAWINGS

The above and other objects and features will become apparent from the following description with reference to the following figures, wherein like reference numerals refer to like parts throughout the various figures unless otherwise specified, and wherein:

FIG. 1 illustrates a substrate inspection apparatus according to an exemplary embodiment;

FIG. 2 is a cross-sectional view of a liquid crystal modulator according an exemplary embodiment;

FIG. 3 is a cross-sectional view of a liquid crystal modulator according to another exemplary embodiment;

FIG. 4A is a cross-sectional view illustrating a manufacturing method of the liquid crystal modulator in FIG. 3;

FIG. 4B is a cross-sectional view illustrating another manufacturing method of the liquid crystal modulator in FIG. 3;

FIG. 5 is a cross-sectional view of a liquid crystal modulator according to another exemplary embodiment;

FIG. 6 is a cross-sectional view illustrating a manufacturing method of the liquid crystal modulator in FIG. 5;

FIG. 7 is a cross-sectional view of a liquid crystal modulator according to another exemplary embodiment;

FIG. 8 is a cross-sectional view illustrating a manufacturing method of the liquid crystal modulator in FIG. 7;

FIGS. 9 to 11 are cross-sectional views of liquid crystal modulators according to exemplary embodiments;

FIG. 12 is a graph showing reflected luminances depending on voltages of a liquid crystal modulator according to an embodiment and a conventional liquid crystal modulator;

FIG. 13 is a graph showing reflectances when a liquid crystal layer is of a polymer network liquid crystal and a polymer dispersed liquid crystal display in a liquid crystal modulator according to an exemplary embodiment; and

FIG. 14 is a graph showing detectable minimum pitch of a pixel depending on thickness of a liquid crystal modulator according to an exemplary embodiment.

### DETAILED DESCRIPTION

Exemplary embodiments will now be described more fully with reference to the accompanying drawings, in which exemplary embodiments are shown. Exemplary embodiments may, however, be embodied in many different forms and should not be construed as limited to the embodiments set forth herein. Rather, these exemplary embodiments are provided so that this description will be thorough and complete, and will fully convey the concept of exemplary embodiments to those of ordinary skill in the art. In the drawings, the thicknesses of layers and regions are exaggerated for clarity.

The terms used in the specification are for the purpose of describing particular embodiments only and are not intended to be limiting of the invention. As used in the specification, the singular forms “a”, “an” and “the” are intended to include the plural forms as well, unless the context clearly indicates otherwise. It will be further understood that the terms “comprises” and/or “comprising”, when used in the specification, specify the presence of stated features, integers, steps, operations, elements, and/or components, but do not preclude the presence or addition of one or more other features, integers, steps, operations, elements, components, and/or groups thereof.

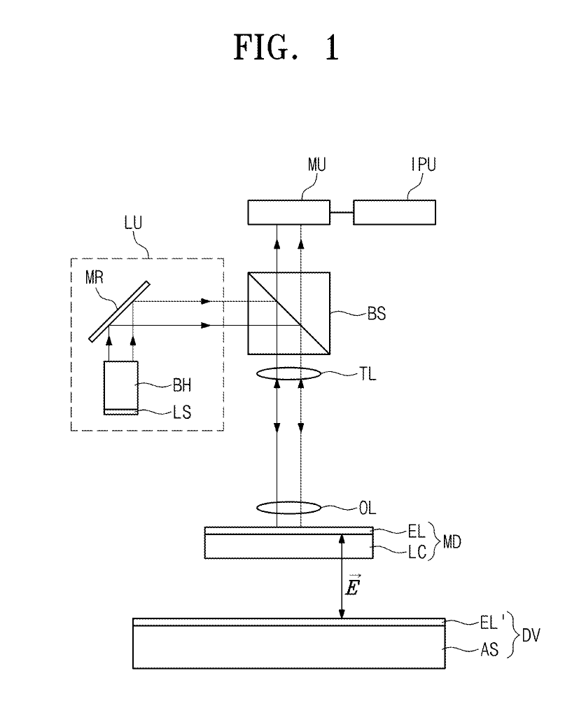

FIG. 1 illustrates a substrate inspection apparatus according to an embodiment of the present invention. The substrate inspection apparatus detects defects of a display device, more specifically, detects on a display substrate for use in a display device. Types of the display device are not limited. For example, the display device may be a liquid crystal display (LCD), an electrowetting display, an electrophoretic display or an organic light emitting display (OLED).

The display device may include a plurality of pixels. The display device may include a display substrate DV where a plurality of thin film transistors corresponding to the pixels are formed, an opposite substrate (not shown) facing the display substrate DV, and an image display layer (not shown) disposed between the display substrate DV and the opposite substrate. The image display layer may be a liquid crystal layer in case of the liquid crystal display, an electrowetting layer in case of the electrowetting display, an electrophoretic layer in case of the electrophoretic display, and an organic light emitting layer in case of the organic light emitting display. The opposite substrate may be replaced with an encapsulation film according to type and structure of the display device.

In an exemplary embodiment, the display substrate DV may be used in a liquid crystal display. For example, the display substrate DV may be used in different modes of LCDs such as a plane to line switching (PLS) mode LCD, a fringe field switching (FFS) mode LCD, a vertical alignment (VA) mode LCD, a twisted nematic (TN) mode LCD, a pattern vertical alignment (PVA) mode LCD, and an in-plane switching (IPS) mode LCD.

The display substrate DV may include an array substrate AS where the thin film transistors are formed and a target electrode EL′ disposed on the array substrate AS. The target electrode EL′ may be provided in plurality to correspond to each pixel.

Although not shown in the drawing, the array substrate AS may include an insulating substrate. The thin film transistor is disposed on the insulating substrate. The thin film transistors may be electrically connected to at least some of the target electrodes EL′ to apply a predetermined voltage (e.g., about 10 volts) to the target electrode EL′.

Hereinafter, the configuration and operating principle of the substrate inspection apparatus will now be described in detail.

A substrate inspection apparatus according to an embodiment includes a light source unit LU, a beam splitter BS, a liquid crystal modulator MD, a measurement unit MU, and an image processing unit IPU.

The light source unit LU outputs a light. In an exemplary embodiment, the light source unit LU may include a light source LS to emit a beam of light, a beam homogenizer BH to direct the beam emitted from the light source LS and homogenize the directed beam, and a reflector MR.

The light source LS is not limited and may be any one of components to emit a beam of light. In an exemplary embodiment, the light source LS may be a light emitting diode, laser or the like.

The beam homogenizer BH directs the beam emitted from the light source LS to the reflector MR to homogenize a point light source in the form of a surface light source. In an exemplary embodiment, the beam homogenizer BH may be provided in the form of a rod pipe having one end and the other end. The light source LS may be opposite to one end and the reflector MR may be opposite to the other end. In an exemplary embodiment, the light source LS may be provided in a shape of a pipe at one side of the beam homogenizer BH. In this case, the possibility of light loss due to a reflection at one end of the beam homogenizer may be decreased.

The beam of light travels from the one end to the other end and is emitted to the reflector MR through the other end of the beam homogenizer BH. The beam of light emitted from the light source LS is total-reflected two or more times in the beam homogenizer BH before it is exited from the beam homogenizer BH. Thus, the beam of light exited from the beam homogenizer BH has uniform density within a predetermined area.

The reflector MR is provided between the beam homogenizer BH and the beam splitter BS to reflect the light. In other words, a light path is changed such that the beam of light emitted from the other end of the beam homogenizer BH travels toward a direction of the beam splitter BS. In an exemplary embodiment, when the other end of the beam homogenizer BH is directly opposite to the beam splitter BS, the beam of light emitted from the beam homogenizer BH may travel to the beam splitter BS without the reflector MR. In this case, the reflector MR may be omitted.

An optical lens may be further provided between the beam splitter BS and the reflector MR to condense or expand beam of light. For example, in an embodiment, a beam expander (not shown) may be provided between the beam splitter BS and the reflector MR to expand the beam of light.

The beam splitter BS provides the beam of light emitted from the light source unit LU to the side of the liquid crystal modulator MD after splitting the beam of light into a plurality of light elements. The beam splitter BS may be a polarizing beam splitter to split incident beam of light into two linearly polarized beams (e.g., S-wave and P-wave).

A polarizer (not shown) may be further provided to at least one side of the beam splitter BS to enhance polarizing efficiency of the beam splitter BS. For example, a polarizer may be provided between the light source unit LU and the beam splitter BS and/or between the beam splitter BS and the measurement unit MU to polarize beam of light impinging on the beam splitter BS in a predetermined polarizing direction. The polarizer may certainly divide beam of light impinging on the beam splitter BS and beam of light emitted from the beam splitter BS into a predetermined polarizing direction, e.g., S-wave or P-wave.

The liquid crystal modulator MD is an element for determining whether pixels are good or bad in the display substrate DV. The liquid crystal modulator MD is disposed on the display substrate DV with a predetermined distance between the liquid crystal modulator MD and the display substrate DV. The liquid crystal modulator MD shows different transmittance or reflectance depending on whether or not there is a defect in the display substrate DV and indicates whether the pixels are good or bad. The liquid crystal modulator MD includes an electrode EL (hereinafter referred to as “a common electrode” to distinguish the electrode from a target electrode EL′ of the display DV) and a liquid crystal layer LC. The liquid crystal modulator MD will be explained in detail later with reference to drawings.

One or more optical lenses may be provided between the beam splitter BS and the liquid crystal modulator MD to adjust a path of light traveling between the beam splitter BS and the liquid crystal modulator MD. The optical lens converges or diverges the light, or allows the light to travel in parallel. For example, in an exemplary embodiment, the lens may include a tube lens unit TL disposed at the side of the beam splitter BS and an objective lens unit OL disposed at the side of the liquid crystal modulator MD. Each of the tube lens unit TL and objective lens units OL may include at least one lens. In an exemplary embodiment, both the tube lens unit TL and the objective lens unit OL may be telecentric lenses.

The beams of light split by the beam splitter BS may travel in correspondence with different positions of the display substrate DV and may be reflected by the liquid crystal modulator MD. When the split beam is reflected at the liquid crystal modulator MD, the split beams may be provided to the measurement unit MU through the beam splitter BS. The split beams may substantially be in one-to-one correspondence to positions of respective target electrodes EL′.

The measurement unit MU measures the beams of light that passes through the beam splitter BS after being reflected at the liquid crystal modulator MD. The measurement unit MU may include a plurality of charge-coupled devices (CCDs). The measurement unit MU may generate data signals corresponding one-to-one to light intensities of the split beams using the CCDs. In an exemplary embodiment, the split beams may be provided to three of the CCDs which are in one-to-one correspondence to the split beams.

A condensing unit (not shown) may be provided between the beam splitter BS and the measurement unit MU. The condensing unit condenses split beam of light reflected at the liquid crystal modulator MD. In an exemplary embodiment, the condensing unit may be a lens having a convex surface.

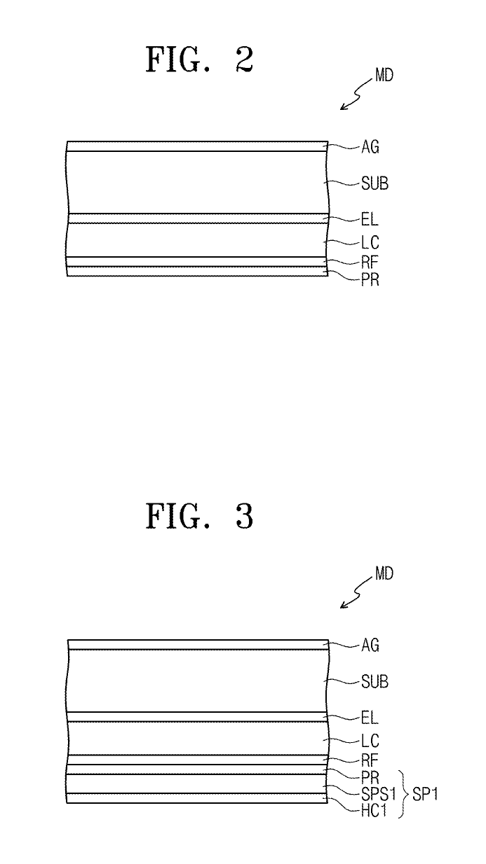

FIG. 2 is a cross-sectional view of a liquid crystal modulator MD according an embodiment.

Referring to FIGS. 1 and 2, the liquid crystal modulator MD includes a common electrode EL facing the target electrode EL′ of the display substrate DV, a liquid crystal layer LC provided on the common electrode EL, and a reflection layer RF provided on the liquid crystal layer LC.

More specifically, the common electrode EL is provided on a transparent electrode SUB. Of the transparent substrate SUB, one surface on which the common electrode EL is provided faces the display substrate DV and the other surface on which the common electrode EL is not provided faces the beam splitter BS. An anti-reflection layer AG may be provided on the other surface of the transparent substrate SUB. A protection layer PR may be provided on the reflection layer RF to protect the refection layer RF. The liquid crystal modulator MD may include the anti-reflection layer AG, the transparent substrate SUB, the common electrode EL, the liquid crystal layer LC, the reflection layer RF, and the protection layer PR which are arranged in the order of distance from the display substrate DV. These elements will now be explained below.

The transparent substrate SUB may be an insulating substrate made of quartz, glass, plastic or the like.

The anti-reflection layer AG is provided on the transparent substrate SUB on a surface facing the beam splitter BS and may be omitted in another embodiment.

The common electrode EL is provided on the transparent substrate SUB on a surface facing the display substrate DV. The common electrode EL may be applied with a voltage having a predetermined magnitude, e.g., about 150 volts to about 350 volts and may establish an electric field E together with the target electrode EL′. The common electrode EL may be made of a transparent material such as indium tin oxide (ITO), indium zinc oxide (IZO), indium tin zinc oxide (ITZO), and conductive polymer. The common electrode EL may be formed to a thickness of about 25 micrometers to about 100 micrometers.

In an exemplary embodiment, the common electrode EL may be provided directly on the transparent substrate SUB. The common electrode may be in direct contact with one surface of the transparent substrate SUB. However, the common electrode EL may be attached to the transparent substrate using an adhesive layer.

The liquid crystal layer LC includes a liquid crystal LC, being used as an image display layer to transmit or block a beam of light according to the electric field E established between the common electrode EL and the target electrode EL. In the liquid crystal modulator MD according to an embodiment, the liquid crystal layer LC may include a polymer network liquid crystal (PNLC).

In an exemplary embodiment, the liquid crystal layer LC has a cell gap of about 2 micrometers to about 50 micrometers. When the cell gap of the liquid crystal layer LC is greater than about 50 micrometers, a driving voltage of the liquid crystal layer LC increases excessively and response speed is significantly reduced. When the cell gap of the liquid crystal layer LC is less than 2 micrometers, a driving voltage of the liquid crystal layer LC decreases and response speed is improved but a contrast ratio is reduced.

The polymer network liquid crystal is a type of polymer-stabilized liquid crystal and may include a polymer network and a liquid crystal compound. The polymer forms the polymer network and the liquid crystal compound is provided in a domain.

The polymer network is a net-shaped structure made of polymer. The polymer may constitute a network through polymerization but is not limited in type. The polymer is formed by polymerizing a monomer (including a dimer or precursor) of a polymer having a photocurable functional group. For example, the polymer may be methacrylate, diacrylate, triacrylate, dimethacrylate, trimethacrylate or a polymerized material of their mixture. In addition, the polymer may be a polymerized material of reactive mesogen.

In the domain, the liquid crystal compound is provided. The domain may be provided with various forms such as pillar, horn-shaped pillar, web, and net. The liquid crystal compound may be phase-separated from the polymer network and dispersed in the domain of the polymer network. The liquid crystal compound may not be limited in particular as long as it is able to exist within the polymer network having a phase separated from the polymer network and having an alignment direction. For example, the liquid crystal compound may include a smetic liquid crystal compound, a nematic liquid crystal compound, a cholesteric liquid crystal compound or the like. Because the liquid crystal compound is phase-separated and is not bound to the polymer network, the orientation of the liquid crystal compound varies depending on an external electric field applied to the liquid crystal compound.

In some embodiments, the polymer and the liquid crystal compound may be provided with a composition ratio of 1:1. However, the composition ratio of the polymer to the liquid crystal compound is not limited thereto and may have another composition ratio.

In some embodiments, the polymer network liquid crystal may be formed by preparing a mixture of photocurable polymerizable monomer (including dimer or polymeric precursor) and a liquid crystal composition and curing the polymer using a light such as ultraviolet or inducing phase separation of the liquid crystal and the polymer. The liquid crystal composition may further include a photoinitiator for initiating a polymerization reaction of the polymer. In other embodiments, the polymer may be cured by applying heat to the liquid crystal composition.

A network is formed while curing the polymer. A liquid crystal composition is disposed in the domain formed by the network. Under the condition that an electric field is not applied to the PNLC, the polymer network liquid crystals in the domain are arranged at random. Thus, although a beam of light impinges, the impinging beam of light is scattered by a difference in refractive index between the liquid crystal and the polymer. Under the condition that an electric field is applied to the polymer network liquid crystal, liquid crystals in the domain are arranged in a predetermined direction by the electric field. If the liquid crystal is a liquid crystal having positive dielectric anisotropy, the liquid crystal is arranged in parallel to a direction of electric field and if the liquid crystal is a liquid crystal having negative dielectric anisotropy, the liquid crystal is arranged perpendicular to a direction of electric field. If a refractive index of a liquid crystal domain is made equal to that of polymer, incident light passes through both the liquid crystal and the polymer. Thus, the liquid crystal is brought into a transparent state to display an image. The polymer network liquid crystal does not need a polarizer and may be manufactured by a simple method. In addition, the polymer network liquid crystal may be manufactured to be flexible depending on the kind of polymer.

A liquid crystal compound used in the polymer network liquid crystal may have refractive index anisotropy of about 0.05 to about 0.2 and have dielectric anisotropy of about 2 to about 50.

In some embodiments, the liquid crystal layer LC further comprises an alignment layer to initially align the polymer network liquid crystal. In this case, the alignment layer may be provided to make contact with the common electrode EL and the reflection layer RF. The alignment layer is not limited in particular as long as it is able to initially align the polymer network liquid crystal and may include, for example, polyimide or polyamic acid.

In this case, unlike the conventional method, an insulating layer is not required between the common electrode EL and the liquid crystal layer LC.

The reflection layer RF reflects a beam of light provided from the beam splitter BS and traveling through the liquid crystal layer LC. A wavelength of the beam reflected by the reflection layer RF may vary depending on a wavelength of beam of light detected by a measurement unit that will be explained later. In an exemplary embodiment, the wavelength of the reflected beam may be about 380 nanometers to about 700 nanometers. In an exemplary embodiment, thickness of the reflection layer RF may be about 3 micrometers or less and may range from about 2 micrometers to about 3 micrometers.

The reflection layer RF is not particularly limited and may be any layer to reflect a beam of light. The reflection layer RF may include a metal layer or a dielectric mirror.

The dielectric mirror includes a plurality of dielectric layers having different refractive indexes. For example, the dielectric mirror may include a first dielectric layer having a first refractive index and a second dielectric layer having a second refractive index which are arranged alternately at least two or more times. The first refractive index and the second refractive index may be different from each other, and dielectric constants of the first and second dielectric layers may be about 7 or less.

In an exemplary embodiment, the first dielectric layer may include zirconium oxide and the second dielectric layer may include silicon oxide. In an exemplary embodiment, a refractive index of the zirconium oxide may be 1.67 to 1.72 and a refractive index of the silicon oxide may be 1.34 to 1.46. In an alternative embodiment, the first dielectric layer may include titanium oxide and the second dielectric layer may include silicon oxide.

The sum total of the first and second dielectric layers may be three or more layers. In exemplary embodiments, the sum total of the first and second dielectric layers may be 15 layers or more.

The protection layer PR may protect the reflection layer RF and may be formed on the reflection layer RF to a thickness of about 0.1 micrometer to about 0.2 micrometer.

The above-configured liquid crystal modulator MD may be manufactured by forming a common electrode EL on a transparent substrate SUB, forming a liquid crystal layer LC directly on the common electrode EL, and forming a reflection layer RF on the liquid crystal layer LC.

The common electrode EL may be formed directly on the transparent substrate SUB without intervening adhesive layer and may be formed by depositing or coating indium tin oxide (ITO), indium zinc oxide (IZO), indium tin zinc oxide (ITZO), conductive polymer or the like.

The liquid crystal layer LC may include a polymer network liquid crystal. The liquid crystal layer LC including the polymer network liquid crystal may be formed by means of phase separation or emulsification. The phase separation includes polymerization induced phase separation (PIPS), thermally induced phase separation (TIPS), and solvent induced phase separation (SIPS). In an exemplary embodiment, the polymer network liquid crystal may be formed by one of the above methods. The polymer network liquid crystal may be formed by coating a polymer network liquid crystal composition on the common electrode EL and curing the polymer network liquid crystal composition.

The polymer network liquid crystal composition may include a liquid crystal, a liquid polymerizable monomer (or dimer or precursor), and a solvent. In some embodiments, a ratio of the liquid crystal to the polymerizable monomer may be 1:1. The polymer network liquid crystal composition may be coated on the common electrode EL by means of spin coating, doctor blade coating or slot die coating.

The polymer network liquid crystal composition and the cured polymer network liquid crystal include a polymerizable monomer or a polymerized polymer. Surface energy of the polymer network liquid crystal composition and the cured polymer network liquid crystal may be decided depending on the kind of the polymer. Thus, they may play a role as an adhesive. As a result, the liquid crystal layer LC according to an embodiment may be formed directly on the common electrode EL without use of an adhesive.

The reflection layer RF may be formed by forming a metal layer or a dielectric mirror on the liquid crystal layer LC. The dielectric mirror may be formed by sequentially forming dielectric materials having different refractive indexes on the liquid crystal layer LC. The method of forming the reflection layer RF is not particularly limited. For example, an en exemplary embodiment, the reflection layer RF may be formed by sequentially coating a zirconium oxide solution and a silicon oxide solution including suitable solvent and/or organic material. In this case, a high-temperature deposition process is not required.

A protection layer PR is formed on the reflection layer RF. The protection layer PR may be coated with an organic material, e.g., a polymer resin.

An anti-reflection layer AG may be coated on the transparent substrate SUB. The formation order of the anti-reflection layer AG is not particularly limited. For example, in an exemplary embodiment, the anti-reflection layer AG may be formed on the transparent substrate SUB before formation of the common electrode EL or may be formed on the transparent substrate SUB after formation of the transparent substrate SUB, the common electrode EL, the liquid crystal layer LC, the reflection layer RF, and the protection layer PR. Hereinafter, in respective embodiments, the formation order of the anti-reflection layer AG will follow the foregoing embodiment as long as particularly mentioned herein and duplicate explanations will be omitted.

In the liquid crystal modulator MD according to an embodiment, the common electrode EL is formed directly on the transparent substrate SUB without being separately formed and being attached to the substrate SUB. Therefore, an adhesive for attaching the common electrode EL to the transparent substrate SUB may be omitted. In addition, an insulating layer between common electrode EL and the liquid crystal layer LC may be omitted by forming the liquid crystal layer LC on the common electrode EL without intervening insulating layer. The liquid crystal layer LC is used as an adhesive and thus an additional adhesive for bonding the reflection layer RF to the liquid crystal layer LC is not required. As a result, the total thickness between a target electrode EL′ of a display substrate and the common electrode EL of the liquid crystal modulator MD may be reduced.

When a distance between the target electrode EL′ and the common electrode EL becomes great, an electric field applied to the liquid crystal layer LC may be reduce and the liquid crystal layer LC may not be driven as intended. However, since the thickness between the target electrode EL′ and the common electrode EL is reduced, an influence of the electric field on the liquid crystal layer LC increases. Thus, a contrast ratio and response speed of the liquid crystal layer LC of the liquid crystal modulator MD may increase. As a result, a voltage required to be applied to the common electrode EL of the liquid crystal modulator MD may be reduced. For example, in an exemplary embodiment, even when a detection voltage applied to the common electrode EL is less than 305 volts, the liquid crystal modulator MD may be driven, the liquid crystal layer LC may have response speed of 30 milliseconds or less, and a contrast ratio may exhibit about 10:1 or higher.

A distance between the liquid crystal modulator MD and the display substrate DV must be suitably maintained such that a foreign substance may not cause a scratch to the display substrate DV or the liquid crystal modulator MD. Since thickness in the liquid crystal modulator MD decreases, the distance between the liquid crystal modulator MD and the display substrate DV may be sufficiently maintained while constantly maintaining a distance between the target electrode EL′ and the common electrode EL. Thus, a foreign substance defect of the display substrate DV or the liquid crystal modulator MD is reduced.

FIG. 3 is a cross-sectional view of a liquid crystal display according to another embodiment. Hereinafter, for the convenience of description, in a liquid crystal display modulator MD according to another embodiment, differences from the above-describe embodiment will be mainly described and omitted parts will follow the above-described embodiment.

Referring to FIGS. 1 and 3, the liquid crystal modulator MD includes a common electrode EL opposite to a target electrode EL′ and provided on a transparent substrate SUB, a liquid crystal layer LC provided on the common electrode EL, a reflection layer RF provided on the liquid crystal layer LC, and a support part (hereinafter referred to as “first support part SP1” to be distinguished from another component explained later) provided on the reflection layer RF. An anti-glare layer AG is provided on the transparent substrate SUB, and the first support part SP1 includes a protection layer PR, a first support sheet SPS1, and a first hard coating layer HC1.

In other words, the liquid crystal modulator MD includes the transparent substrate SUB, the common electrode EL, the liquid crystal layer LC, the reflection layer RF, the protection layer PR, the first support sheet SPS1, and the first hard coating layer HC1 that are arranged in the order of distance from the display substrate DV.

The first support sheet SPS1 may be provided with thickness enough to support the reflection layer RF. For example, in an exemplary embodiment of the present invention, the first support sheet SPS1 may have a thickness of about 2 micrometers to about 6 micrometers or a thickness of about 2.2 micrometers. The first support sheet SPS1 is provided such that beam of light passing therethrough have no phase difference.

The first support sheet SPS1 may be made of a material having high tensile strength and excellent heat resistance, e.g., an organic polymeric material. The organic polymeric material may be at least one of polycarbonate, polyethylene terephthalate, cyclo-olefin polymer, celluloid, and triacetyl cellulose.

The first hard coating layer HC1 may include at least one of ultraviolet (UV) curable polymer, sol-gel material, thermosetting polymer, and an organic and inorganic composite material. The first hard coating layer HC1 is coated on the first support sheet SPS1 to protect the firs support sheet SPS1 from scratch or the like and facilitate ease of handling during a process of the first support part SP1. For achieving this, in an exemplary embodiment, hardness of the first hard coating layer HC1 may be 2H or higher and thickness of the first hard coating layer HC1 may be about 3 micrometers to about 4 micrometers. In this case, a dielectric constant of the first hard coating layer may be 4 or less.

The first support sheet SPS1 and the first hard coating layer HC1 may have a transmittance of 95 percent or more.

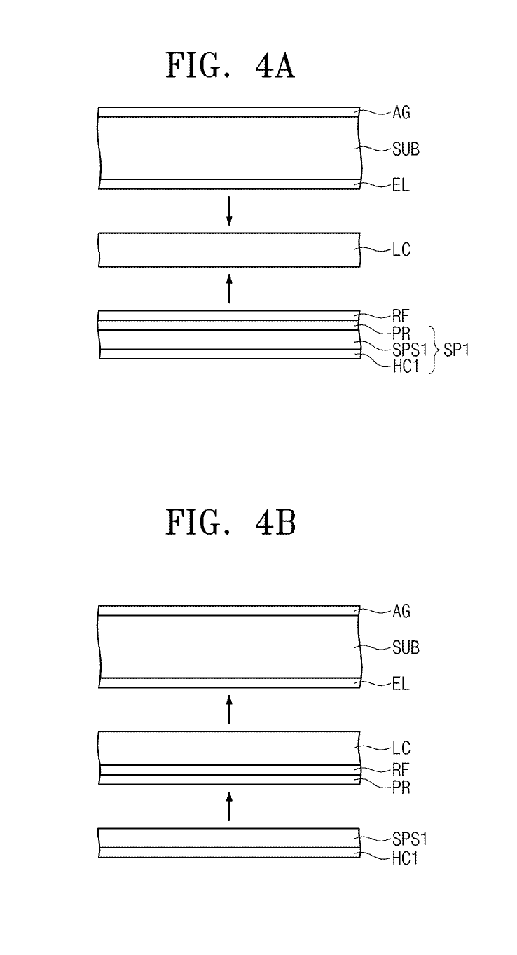

FIG. 4A is a cross-sectional view illustrating a manufacturing method of the liquid crystal modulator MD in FIG. 3.

Referring to FIGS. 1, 3, and 4A, the liquid crystal modulator MD may be manufactured by forming a common electrode EL on a transparent substrate SUB, forming a first support part SP1, forming a reflection layer RF on the first support part SP1, and forming a liquid crystal layer LC between the common electrode EL and the reflection layer RF. Unlike the above-described embodiment, this embodiment is characterized in that after a reflection layer RF is formed on a first support part SP1, the common electrode EL and the reflection layer RF are formed to face each other using the liquid crystal layer LC as an adhesive. This will now be described in detail below.

First, the common electrode EL is formed directly on the transparent substrate SUB to be in contact therewith.

The first support part SP1 is fabricated by preparing a first support sheet SPS1, forming a first hard coating layer HC1 on one surface of the first support sheet SPS1, and forming a protection layer PR on the other surface of the first support sheet SPS1.

The first hard coating layer HC1 may be coated on one surface of the first support sheet SPS1 by means of various manners such as, spin coating, doctor blade coating, and slot die coating.

The protection layer PR may be coated on the other surface of the first support sheet SPS1, on which the first hard coating layer HC1 is not formed, by means of various manners such as spin coating, doctor blade coating, and slot die coating. The protection layer PR may be made of a material including an organic polymeric resin.

The reflection layer RF is formed on the first support part SP1 on the protection layer PR. The reflection layer RF may be formed by forming a metal layer or a dielectric mirror on the liquid crystal layer LC. The dielectric mirror may be formed by sequentially forming organic materials having different diffractive indices on the protection layer PR. However, a method of forming the reflection layer RF is not particularly limited. For example, in an exemplary embodiment, the reflection layer RF may be formed by sequentially coating a zirconium oxide solution and a silicon oxide solution including suitable solvent and/or organic material. In this case, a high-temperature deposition process is not required.

Next, a liquid crystal layer LC is formed between the transparent substrate SUB on which the common electrode EL is formed and the first support part SP1 on which the reflection layer RF is formed. The liquid crystal layer LC serves as an adhesive to bond the transparent substrate SUB on which the common electrode EL is formed and the first support part SP1 on which the reflection layer RF is formed. In this case, the liquid crystal layer LC is in direct contact with the common electrode EL and the reflection layer RF. The liquid crystal layer LC may be formed by locating a polymer network liquid crystal composition between the common electrode EL and the reflection layer RF and curing the polymer network liquid crystal composition.

FIG. 4B is a cross-sectional view illustrating another manufacturing method of the liquid crystal modulator MD in FIG. 3.

Referring to FIGS. 1, 3, and 4B, the liquid crystal modulator MD may be manufactured by forming a common electrode EL on a transparent substrate SUB, sequentially forming a reflection layer RF and a protection layer PR on a liquid crystal layer LC, forming a first support sheet SPS1 and a first hard coating layer HC1, letting the liquid crystal layer LC adhere onto the common electrode EL, and laminating the first support sheet SPS1 on the protection layer PR. This will now be described in detail below.

First, the common electrode EL is formed directly on the transparent substrate SUB to be in contact therewith.

Apart from the transparent substrate SUB and the common electrode EL, a reflection layer RF and a protection layer PR are sequentially formed on the liquid crystal layer LC. The liquid crystal layer LC may adjust strength (or hardness) and adhesiveness by adjusting the degree of curing. The reflection layer RF and the protection layer PR are sequentially formed on the liquid crystal layer LC. The reflection layer RF may be formed by forming a metal layer or a dielectric mirror on the liquid crystal layer LC. The dielectric mirror may be formed by sequentially forming dielectric materials having different diffractive indices on the liquid crystal layer LC. The protection layer PR may be coated by means of various manners such as spin coating, doctor blade coating, and slot die coating.

The protection layer PR, a first support sheet SPS1 is prepared and a first hard coating layer HC1 is formed on the first support sheet SPS1. The first hard coating layer HC1 may be coated on one surface of the first support sheet SPS1 by means of various manners such as spin coating, doctor blade coating, and slot die coating. Since the liquid crystal layer LC has sufficient thickness of about 20 micrometers to about 25 micrometers, the reflection layer RF may be easily coated on the liquid crystal layer LC.

Next, the liquid crystal layer LC adheres onto the common electrode EL without intervening insulating layer. Thus, the transparent substrate SUB, the common electrode EL, the liquid crystal layer LC, the reflection layer RF, and the protection layer PR are sequentially stacked. Next, the first support sheet SPS1 is laminated on the protection layer PR.

As explained above, similar to the liquid crystal modulator MD according to an embodiment, the liquid crystal modulator MD according to another embodiment is characterized in that an adhesive for bonding the common electrode EL to the transparent substrate SUB is omitted because after the common electrode EL may be separately fabricated, it is formed directly on the transparent substrate SUB without adhering to the transparent substrate SUB. In addition, since the liquid crystal layer LC is formed on the common electrode EL without intervening insulating layer, an insulating layer between the common electrode EL and the liquid crystal layer LC may be omitted. Moreover, since the liquid crystal layer LC is used as an adhesive, an additional adhesive for bonding the reflection layer RF to the liquid crystal layer LC is not required. As a result, total thickness between a target electrode EL′ of a display substrate DV and the common electrode EL of the liquid crystal modulator MD may be reduced.

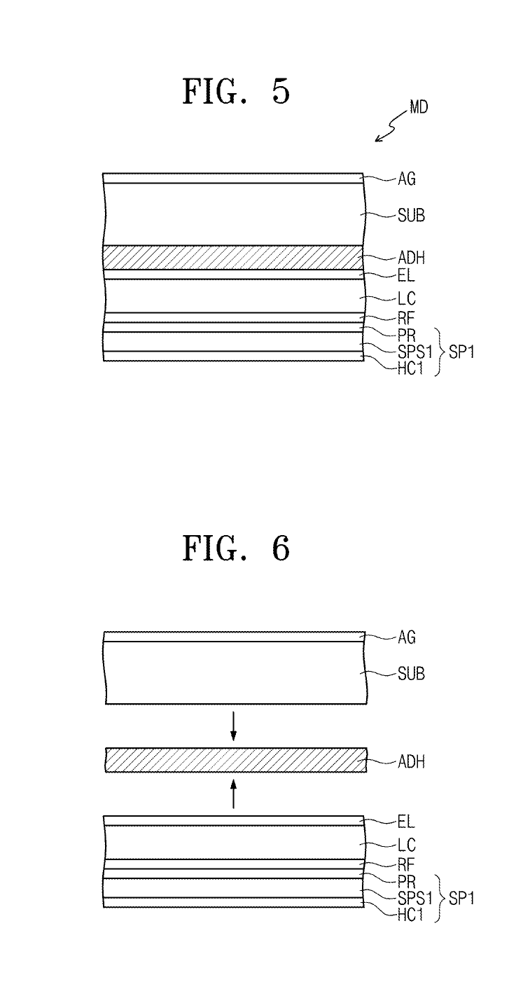

FIG. 5 is a cross-sectional view of a liquid crystal modulator MD according to another embodiment. Hereinafter, for the brevity of description, the description will focus on differences of this embodiment from the embodiment described in FIG. 3 and the elements that are the same as those described in the previous embodiments shall be omitted.

Referring to FIG. 5, the liquid crystal modulator MD includes a common electrode EL facing a target electrode EL′ of a display substrate DV and provided on a transparent substrate SUB with an adhesive ADH interposed therebetween, a liquid crystal layer LC provided on the common electrode EL, a reflection layer RF provided on the liquid crystal layer LC, and a first support part SP1 provided on the reflection layer RF. An anti-glare layer AG is provided on the transparent substrate SUB, and the first support part SP1 includes a protection layer PR, a first support sheet SPS1, and a hard coating layer.

In other words, the liquid crystal modulator MD includes the transparent substrate SUB, the adhesive ADH, the common electrode EL, the liquid crystal layer LC, the reflection layer RF, the protection layer PR, the first support sheet SPS1, and the hard coating layer which are arranged in the order of distance from the display substrate DV.

The adhesive ADH is optically transparent but is not particularly limited. In an exemplary embodiment, the adhesive ADH may include an optically transparent polymeric resin. The adhesive ADH may be provided as a film-type adhesive or a liquid-type adhesive. The adhesive ADH may be formed in various thicknesses depending on the material or adhesiveness of an adhesive. In an exemplary embodiment, the adhesive ADH may have a thickness ranging from about 5 micrometers to about 50 micrometers or a thickness ranging from about 25 micrometers to about 50 micrometers.

FIG. 6 is a cross-sectional view illustrating a manufacturing method of the liquid crystal modulator MD in FIG. 5.

Referring to FIGS. 1, 5, and 6, a transparent substrate SUB is prepared first. After separate fabrication of a common electrode EL, a liquid crystal layer LD, a reflection layer RF, and a first support part SP1 that are sequentially stacked, they may adhere to the transparent substrate SUB with an adhesive ADH interposed therebetween.

The sequentially stacked common electrode EL, liquid crystal layer LC, reflection layer RF, and first support part SP1 may be fabricated by forming a first support part SP1, forming the reflection layer RF on the first support part SP1, forming a liquid crystal layer LC on the reflection layer RF, and forming a common electrode EL on the liquid crystal layer LC.

Alternatively, the sequentially stacked common electrode EL, liquid crystal layer LC, reflection layer RF, and first support part SP1 may be fabricated by sequentially forming a reflection layer RF and a protection layer PR on a liquid crystal layer LC, forming a first hard coating layer HC1 on the first support sheet SPS1, and laminating the first support sheet SPS1 on the protection layer PR.

As explained above, unlike the previous embodiments, the liquid crystal modulator MD according to this embodiment is characterized in that an adhesive ADH is added. However, similar to the liquid crystal display modulator MD according to the previous embodiment, since the liquid crystal layer LC is formed on the common electrode EL without intervening insulating layer, an insulating layer between the common electrode EL and the liquid crystal layer LC may be omitted. Moreover, since the liquid crystal layer LC is used as an adhesive, an adhesive for bonding the reflection layer RF to the liquid crystal layer LC is not required. As a result, the total thickness between a target electrode EL′ of a display substrate and the common electrode EL of the liquid crystal modulator MD may be reduced.

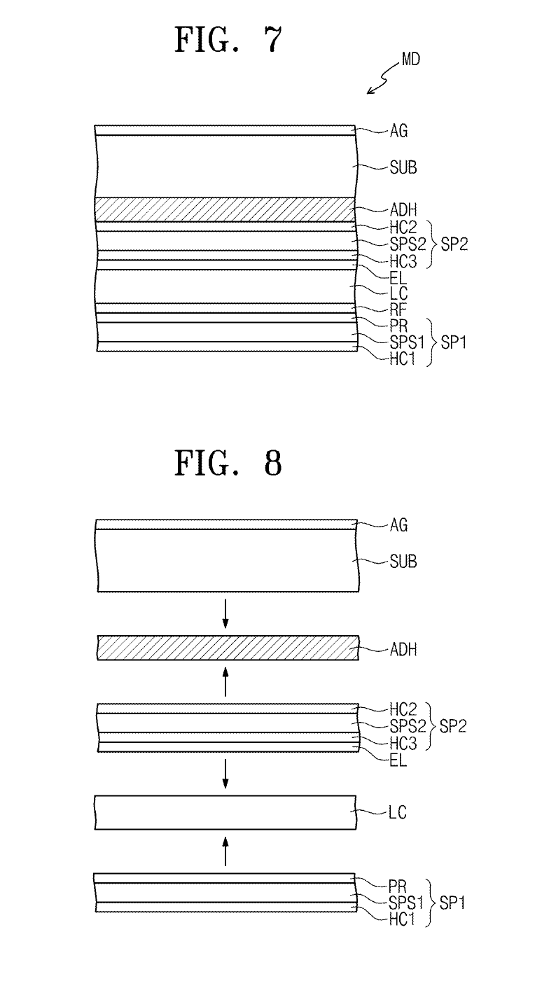

FIG. 7 is a cross-sectional view of a liquid crystal modulator MD according to another embodiment.

Referring to FIG. 7, unlike the liquid crystal modulator MD shown in FIG. 5, the liquid crystal modulator MD according to this embodiment includes a second support part SP2 on which a common electrode EL is formed. That is, the liquid crystal modulator MD according to this embodiment includes a second support part SP2 provided on a transparent substrate SUB with an adhesive interposed therebetween, a common electrode EL provided on the second support part SP2, a liquid crystal layer LC provided on the common electrode EL, a reflection layer RF provided on the liquid crystal layer LC, and a first support part SP1 provided on the reflection layer RF. The first support part SP1 includes a protection layer PR, a first support sheet SPS1, and a hard coating layer HC1. The second support part SP2 includes a second hard coating layer HC2, a second support sheet SPS2, and a third hard coating layer HC3.

In other words, the liquid crystal modulator MD includes the transparent substrate SUB, the adhesive ADH, the second hard coating layer HC2, the second support sheet SPS2, the third hard coating layer HC3, the common electrode EL, the liquid crystal layer LC, the protection layer PR, the first support sheet SPS1, and the first hard coating layer HC1 which are arranged in the order of distance from the display substrate DV.

The second support part SP2 may be provided to have a thickness enough to support the common electrode EL. The total thickness of the second support part SP2 and the common electrode EL may be about 25 micrometers to about 100 micrometers. In an exemplary embodiment, resistance of the common electrode EL may be about 150 ohms or less or about 80 ohms to about 150 ohms, and transmittance of the common electrode EL about 90 percent or more. When the resistance of the common electrode EL is greater than the value, a driving voltage may excessively increase. The total film including the second support part SP2 and the common electrode EL may have a haze value of 1.0 percent to prevent scattering of the liquid crystal layer LC.

The second support sheet SPS2 may be formed of a material having high tensile strength and excellent heat resistance, e.g., an organic polymeric material. The organic polymeric material may be at least one of polycarbonate, polyethylene terephthalate, cyclo-olefin polymer, celluloid, and triacetyl cellulose. The second support sheet SPS2 may comprise a single layer including the organic material but is not limited thereto. The second support sheet SPS2 may comprise multiple layers including the organic material. If the second support sheet SPS2 comprises multiple layers, any one of the multiple layers may be formed of an optically transparent adhesive. The optically transparent adhesive may have a relatively small difference in diffractive index from the transparent substrate SUB. In the present inventive concept, the difference in diffractive index may be about 1.5±0.05. The optically transparent adhesive may be manufactured to have a haze value of about 0.5 percent such that scattering of light passing through the adhesive is minimized.

A second hard coating layer HC2 is provided on one surface of the second support sheet SPS2, and a third hard coating layer HC3 is provided on the other surface of the second support sheet SPS2. Similar to the first hard coating layer HC1, the second hard coating layer HC2 and the third hard coating layer HC3 may include at least one of ultraviolet (UV) curable polymer, sol-gel material, thermosetting polymer, and an organic/inorganic composite material. The second hard coating layer HC2 and the third hard coating layer HC3 are coated on the second support sheet SPS2 to protect the second support sheet SPS2 from scratch or the like and facilitate ease of handling during a process of the second support sheet SPS2. For achieving this, in an exemplary embodiment, hardness of each of the first and second hard coating layers HC1 and HC2 may be 2H or higher and thickness of each of the first and second hard coating layers HC1 and HC2 may be about 3 micrometers to about 4 micrometers. In this case, a dielectric constant of each of the first and second hard coating layers HC1 and HC2 may be 4 or less.

FIG. 8 is a cross-sectional view illustrating a manufacturing method of the liquid crystal modulator MD in FIG. 7.

Referring to FIGS. 1, 7, and 8, a transparent substrate SUB is provided first.

The first support part SP1 is formed. The first support part SP1 is fabricated by preparing a first support sheet SPS1, forming a first hard coating layer HC1 on one surface of the first support sheet SPS1, and forming a protection layer PR on the other surface of the first support sheet SPS1.

A second support part SP2 is prepared and a common electrode EL is formed on the second support part SP2.

The second support part SP2 is fabricated by forming a second hard coating layer HC2 on one surface of the second support sheet SPS2 and forming a third hard coating layer HC3 on the other surface of the second support sheet SPS2. The second and third hard coating layers HC2 and HC3 may be formed on the second support sheet SPS2 by means of substantially the same manner as the first hard coating layer HC1. That is, the second support sheet SPS2 may be formed by coating the second and third hard coating layers HC2 and HC3 on both surfaces of the second support sheet SPS2 by means of various manners, e.g., spin coating, doctor blade coating, and slot die coating.

The common electrode EL may be formed on the second support part SP2. The second supporting part SP2 having the common electrode El on the second supporting part SO2 and the first supporting part SP1 may be bonded to face each other with a liquid crystal layer LC interposed therebetween. The liquid crystal layer LC may serve as an adhesive.

The transparent substrate SUB and the second support part SP2 may be bonded with an adhesive ADH interposed therebetween. In this case, the transparent substrate SUB and the second hard coating layer HC2 of the second support sheet SP2 are bonded to face each other.

As explained above, unlike another embodiment, the liquid crystal modulator MD according to this embodiment is characterized in that an adhesive ADH is added. However, similar to the liquid crystal display modulator MD according to the previously embodiment, since the liquid crystal layer LC is formed on the common electrode EL without interposing adhesive, an insulating layer between the common electrode EL and the liquid crystal layer LC may be omitted. Moreover, since the liquid crystal layer LC is used as an adhesive, an adhesive for bonding the reflection layer RF to the liquid crystal layer is not required. As a result, the total thickness between a target electrode EL′ of a display substrate and the common electrode EL of the liquid crystal modulator MD may be reduced.

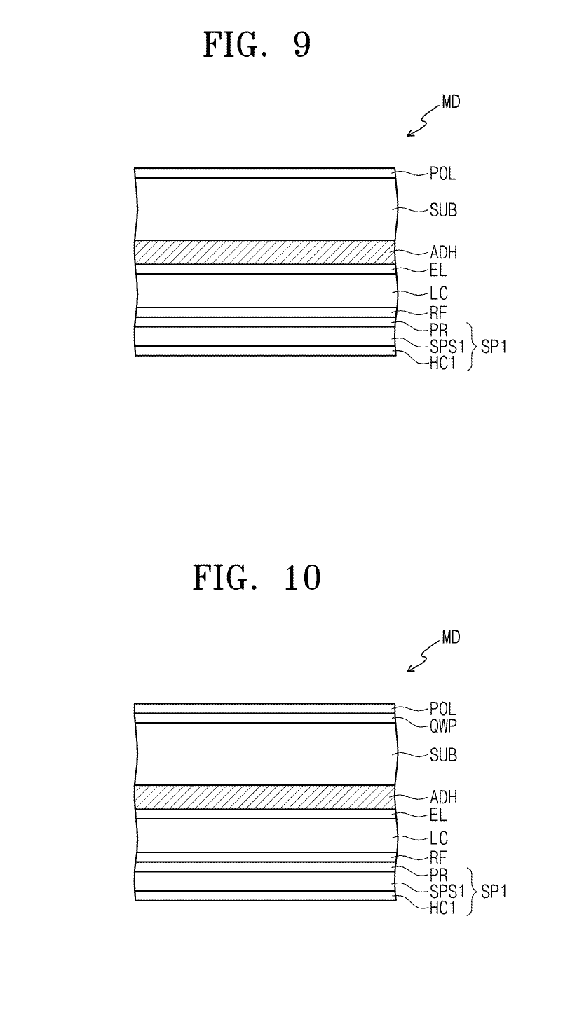

According to some embodiments, additional optical sheets such as a polarizer and a phase delay plate may be provided to maximize beam of light passing through the liquid crystal modulator MD. FIGS. 9 to 11 are cross-sectional views of liquid crystal modulators according to some embodiments.

FIG. 9 illustrates an embodiment of a liquid crystal modulator MD that has substantially the same structure as the liquid crystal modulator MD shown in FIG. 5 but is provided with a polarizer POL. Referring to FIG. 9, the liquid crystal modulator MD includes a common electrode EL disposed to face a target electrode EL′ of a display substrate DV and provided on a transparent substrate SUB with an adhesive ADH interposed therebetween, a liquid crystal layer LC provided on the common electrode EL, a reflection layer RF provided on the liquid crystal layer LC, and a first support part SP1 provided on the reflection layer RF. The polarizer POL is provided on a surface of the transparent substrate SUB that is opposite to the surface on which the common electrode EL is formed, and the first support part SP1 includes a protection layer PR, a first support sheet SPS1, and a hard coating layer. The adhesive ADH may be omitted and the common electrode EL may be formed directly on the transparent substrate SUB.

The polarizer POL is provided to polarize beam of light passing through the liquid crystal modulator MD and filters a noise of the beam of light passing through the liquid crystal modulator MD. When the liquid crystal layer LC includes a polymer network liquid crystal, scattering of beam of light passing through the liquid crystal layer LC increases. In particular, when an electric field is established at the common electrode EL and the target electrode EL′ (see FIG. 1), liquid crystal molecules are aligned by the electric field but the arrangement of liquid crystal molecules disposed around a cured polymer may be disturbed by anchoring energy of the polymer. The beam of light passing through the liquid crystal layer LC may be scattered by the disturbed arrangement of liquid crystals. The scattered beam of light is measured as a noise in the measurement unit MU (see FIG. 1) and may practically prevent detection of light refracted by the liquid crystal modulator MD. Accordingly, in this embodiment, the polarizer POL is provided such that the scattered beam of light is blocked to improve sensitivity of the measurement unit MU.

As shown in this embodiment, the polarizer POL is provided on a surface of the transparent substrate SUB that is opposite to the surface on which the common electrode EL is formed. However, in another embodiment, the polarizer POL may be provided between the transparent substrate SUB and the liquid crystal layer LC. For example, although not shown, the polarizer POL may be provided between the transparent substrate SUB and the adhesive ADH.

In FIG. 10, a liquid crystal modulator MD has substantially the same structure as shown in FIG. 9, but a quarter wave plate QWP is additionally provided between a polarizer POL and a transparent substrate SUB. Referring to FIGS. 9 and 10, the quarter wave plate QWP shifts a phase of light passing through the liquid crystal modulator MD (e.g., converts a linearly polarized light to a circularly polarized light and vice versa). A polarizing axis of the polarizer POL and a polarizing axis of the quarter wave plate QWP are disposed at an angle of 45 degrees with respect to each other.

Accordingly, light passing through the liquid crystal modulator MD is polarized by the polarizer POL and transmittance of light reflected at a reflection layer is improved by the quarter wave plate QWP. As a result, a noise of light passing through the liquid crystal modulator MD is reduced and intensity of the light passing through the liquid crystal modulator is maximized.

As shown in this embodiment, the polarizer POL and the quarter wave plate QWP are provided on a surface of the transparent substrate SUB that is opposite to the surface on which the common electrode EL is formed. However, the positions of the polarizer POL and the quarter wave plate QWP are not limited thereto. In another embodiment, the polarizer POL and the quarter wave plate QWP may be provided between the transparent substrate SUB and the liquid crystal layer LC. For example, although not shown, the polarizer POL and the quarter wave plate QWP may be sequentially provided between the transparent substrate SUB and the adhesive ADH. The adhesive ADH may be omitted and the common electrode EL may be formed directly on the transparent substrate SUB.

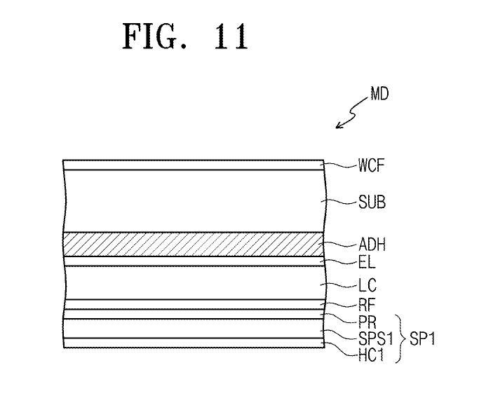

In FIG. 11, a liquid crystal modulator MD has substantially the same structure as shown in FIG. 9, but a wavelength cut-off filter WCF is additionally provided instead of a polarizer POL.

Referring to FIGS. 9 and 10, when light passes through respective components of the liquid crystal modulator MD, transmitting and scattering rates of the light vary depending on a wavelength of the light. Accordingly, light of a specific wavelength is transmitted or scattered more to act as a noise. The wavelength cut-off filter WCF may cut off light of a specific wavelength, particularly light of a shorter wavelength than blue light in the visible light. In an exemplary embodiment, the wavelength cut-off filter WCF may be a short wavelength cut-off filter to cut off light having a shorter wavelength than the blue light, e.g., light having a wavelength of 380 nanometers or less. Thus, after light passes through the liquid crystal modulator MD, a noise of the light measured by the measurement unit MU (see FIG. 1) is reduced. The adhesive ADH may be omitted and the common electrode may be formed directly on the transparent substrate SUB.

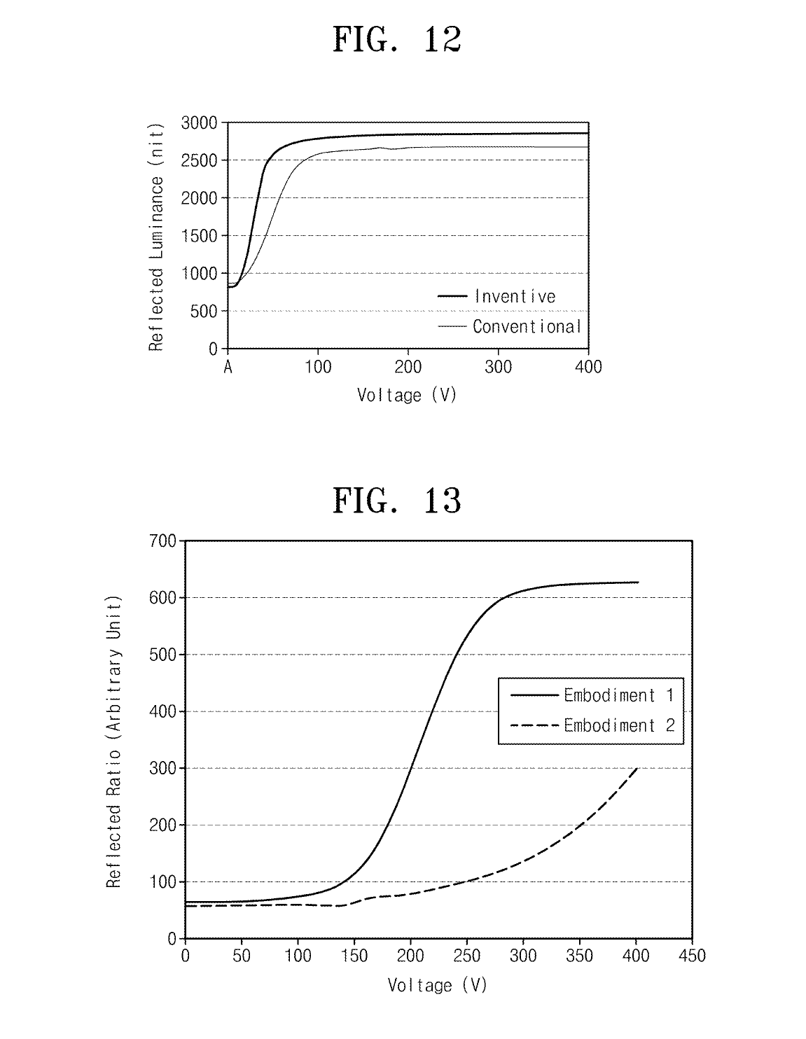

FIG. 12 is a graph showing reflected luminances depending on voltages of a liquid crystal modulator according to an embodiment (Inventive) and a conventional liquid crystal modulator (Conventional). In FIG. 12, a liquid crystal display according to an embodiment employed the liquid crystal display MD described with reference to FIG. 5, and other conditions were kept the same other than the liquid crystal modulator.

Referring to FIG. 12, when the same driving voltage is applied to common electrodes of the liquid crystal modulator according to an embodiment and the conventional liquid crystal modulator, reflected luminance of the liquid crystal modulator according to an embodiment was higher than that of the conventional liquid crystal modulator. Particularly, in the liquid crystal modulator according to an embodiment, the reflected luminance increased at a driving voltage of about 100 volts or more by about 7 percent as compared to the conventional liquid crystal modulator. Thus, in case of the liquid crystal modulator according to an embodiment, a contrast ratio may be improved as compared to the conventional art and defective pixels may be precisely detected than the conventional liquid crystal modulator. Moreover, in case of the liquid crystal modulator according to an embodiment, the same contrast ratio may be obtained at a lower voltage than the conventional art.

FIG. 13 is a graph showing reflective ratio when a liquid crystal layer is a polymer network liquid crystal (Embodiment 1) and a polymer dispersed liquid crystal display (Embodiment 2) in a liquid crystal modulator according to an exemplary embodiment. In the Embodiment 1 and the Embodiment 2, the same structure was used other than a liquid crystal layer and the liquid crystal modulator was driven with 25 Hz. In addition, a distance between the liquid crystal modulator and a display substrate is maintained at 50 micrometers.

From FIG. 13, it can be seen that the reflected ratio of the first embodiment is higher than the reflected ratio of the second embodiment. In other word, a driving voltage to reach the same reflected ratio in the Embodiment 1 employing the polymer network liquid crystal is lower than a driving voltage to reach the same reflected ratio in the Embodiment 2 employing the polymer dispersed liquid crystal. That is, when the polymer network liquid crystal is employed, a defect of a pixel may be easily detected even at a lower driving voltage than when the polymer dispersed liquid crystal is employed. In addition, when the polymer network liquid crystal is employed, a contrast ratio is greater than when the polymer dispersed liquid crystal is employed. Thus, in the liquid crystal modulator that is a final structure, a shape of a defective pixel may be easily visualized when the polymer network liquid crystal is employed.

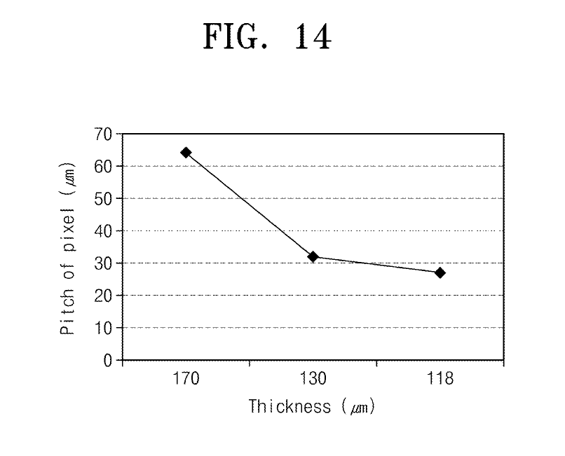

FIG. 14 is a graph showing detectable minimum pitch of a pixel depending on thickness of a liquid crystal modulator according to an embodiment. In FIG. 13, “thickness” of the liquid crystal modulator means a distance from a common electrode to an outermost portion of the liquid crystal modulator that is opposite to a target electrode. That is, “thickness” of the liquid crystal modulator means a distance from the common electrode to a protection layer (an embodiment) or a distance from the common electrode to a first hard coating layer (other embodiments). A distance between from the liquid crystal modulator to a display substrate was maintained at 50 micrometers.

Referring to FIG. 14, a detectable pitch of a pixel is reduced as the liquid crystal modulator decreases in thickness. According to the graph in FIG. 14, when thickness of the liquid crystal modulator is about 118 micrometers, a detectable pitch of a pixel is about 27 micrometers.

As described above, in a liquid crystal modulator according to embodiments, the total thickness between a target electrode of a display substrate and a common electrode of the liquid crystal modulator is reduced, it is possible to detect a defect of a high-resolution substrate having a smaller pitch of a pixel (e.g., display substrate where a pitch of a pixel is about 20 micrometers).

As described so far, there is provided a liquid crystal modulator having a smaller thickness than a conventional liquid crystal modulator. Thus, a contrast ratio can be improved as compared to the conventional art and a defect of a display substrate having a smaller pitch of a pixel can be detected.

While the embodiments have been described with reference to exemplary embodiments, it will be apparent to those skilled in the art that various changes and modifications may be made without departing from the spirit and scope of the present embodiments. Therefore, it should be understood that the above exemplary embodiments are not limiting, but illustrative.

What is claimed is:

1. A substrate inspection apparatus for detecting a defect of a substrate, comprising:
a liquid crystal modulator configured to be provided on the substrate;
a light source unit provided to be spaced apart from the liquid crystal modulator;
a beam splitter provided between the liquid crystal modulator and the light source unit configured to reflect a beam of light from the light source to the liquid crystal modulator; and
a measurement unit configured to sense the beam of light from the liquid crystal modulator,
wherein the liquid crystal modulator comprises:
a transparent substrate;
a common electrode provided on the transparent substrate;
a liquid crystal layer provided on the transparent substrate to be in contact with the common electrode; and
a reflection layer provided on the liquid crystal layer.

2. The substrate inspection apparatus as set forth in claim 1, wherein the light source unit comprises:
a light source configured to emit the beam of light;
a beam homogenizer configured to direct the beam of light emitted from the light source; and
a reflector configured to reflect the beam of light emitted from the beam homogenizer in a direction of the beam splitter.

3. The substrate inspection apparatus as set forth in claim 2, wherein the beam homogenizer is provided in the form of rod pipe.

4. The substrate inspection apparatus as set forth in claim 1, further comprising:
a first support part provided on the reflection layer configured to support the reflection layer and the liquid crystal layer.

5. The substrate inspection apparatus as set forth in claim 4, wherein the first support part comprises:
a first support sheet;
a protection layer provided on one surface of the first support sheet to protect the first support sheet; and
a hard coating layer provided on the other surface of the first support sheet, and wherein the protection layer is provided between the first support sheet and the reflection layer.

6. The substrate inspection apparatus as set forth in claim 5, wherein the hard coating layer includes at least one of ultraviolet (UV) curable polymer, sol-gel material, thermosetting polymer, and an organic and inorganic composite material.

7. The substrate inspection apparatus as set forth in claim 6, wherein the firs support sheet is made of an organic material.

8. The substrate inspection apparatus as set forth in claim 7, wherein the organic material includes at least one of polycarbonate, polyethylene terephthalate, cyclo-olefin copolymer, celluloid, and triacetyl cellulose.

9. The substrate inspection apparatus as set forth in claim 1, wherein the reflection layer comprises a dielectric mirror.

10. The substrate inspection apparatus as set forth in claim 9, wherein the reflection layer comprises:
a plurality of first dielectric layers having a first refractive index; and
a plurality of second dielectric layers having a refractive index differing from the first refractive index,
wherein the first dielectric layers and the second dielectric layers are alternately arranged.

11. The substrate inspection apparatus as set forth in claim 10, wherein the first dielectric layer includes zirconium oxide, and the second dielectric layer includes silicon oxide.

12. The substrate inspection apparatus as set forth in claim 1, wherein the liquid crystal layer includes a polymer network liquid crystal.

13. The substrate inspection apparatus as set forth in claim 12, wherein the polymer network liquid crystal includes a polymer network to form a domain and a liquid crystal compound provided in the domain formed by the polymer network.

14. The substrate inspection apparatus as set forth in claim 1, wherein the common electrode is provided directly on the transparent substrate.

15. The substrate inspection apparatus as set forth in claim 1, further comprising:
an adhesive provided between the transparent substrate and the common electrode; and
a second support part provided between the common electrode and the adhesive layer to support the common electrode.

16. The substrate inspection apparatus as set forth in claim 15, wherein the second support part comprises:
a second support sheet; and
hard coating layers provided on both surfaces of the second support sheet.

17. The substrate inspection apparatus as set forth in claim 1, further comprising:
an image processing unit configured to convert a signal generated by the measurement unit into an image.

18. A manufacturing method of a liquid crystal modulator of a substrate inspection apparatus, comprising:
forming a common electrode on a transparent substrate;
forming a liquid crystal layer directly on the common electrode; and
forming a reflection layer on the liquid crystal layer.

19. The manufacturing method as set forth in claim 18, further comprising:
forming a support part on the reflection layer.

20. The manufacturing method as set forth in claim 19, wherein forming a support part comprises:
preparing a first support sheet;
forming a protection layer on one surface of the first support sheet; and
forming a hard coating layer on the other surface of the first support sheet.

21. The manufacturing method as set forth in claim 18, wherein forming a liquid crystal layer comprises:
coating a polymer network liquid crystal composition on the common electrode; and
curing the polymer network liquid crystal composition.

22. The manufacturing method as set forth in claim 21, wherein the liquid crystal layer is formed by coating the polymer network liquid crystal composition on the common electrode by means of one of spin coating, doctor blade coating, and slot die coating.

23. The manufacturing method as set forth in claim 18, wherein the reflection layer is a dielectric mirror.

24. The manufacturing method as set forth in claim 23, wherein the reflection layer is formed by alternately stacking a plurality of first dielectric layers having a first refractive index and a plurality of second dielectric layers having a refractive index differing from the first refractive index.

25. The manufacturing method as set forth in claim 23, wherein the reflection layer is coated on the liquid crystal layer.

26. The manufacturing method as set forth in claim 23, wherein forming a reflection layer and forming a liquid crystal layer comprise:
forming a support part;
forming a reflection layer on the support part; and
forming a liquid crystal layer between the reflection layer and the common electrode.

27. The manufacturing method as set forth in claim 26, wherein forming a support part comprises:
preparing a first support sheet;
forming a protection layer on one surface of the first support sheet; and
forming a hard coating layer on the other surface of the first support sheet.

28. The manufacturing method as set forth in claim 18, wherein the common electrode is deposited on one surface of the transparent substrate.

29. The manufacturing method as set forth in claim 18, wherein the liquid crystal layer includes a polymer network liquid crystal, and
wherein the polymer network liquid crystal is formed by polymerization induced phase separation (PIPS), thermally induced phase separation (TIPS), or solvent induced phase separation (SIPS).
